(19) United States
(12) Patent Application Publication
(10) Pub. No.: US 2024/0424348 A1
(43) Pub. Date: Dec. 26, 2024

(54) CLIMBING STICK

(71) Applicant: Latitude Outdoors, LLC, Grand Rapids, MI (US)

(72) Inventors: Kevin Leach, Grand Rapids, MI (US); Alex Chopp, Royal Oak, MI (US); Jake Matelic, Royal Oak, MI (US)

(73) Assignee: Latitude Outdoors, LLC, Grand Rapids, MI (US)

(21) Appl. No.: 18/828,633

(22) Filed: Sep. 9, 2024

Related U.S. Application Data
(63) Continuation of application No. 17/829,835, filed on Jun. 1, 2022.

(51) Int. Cl. A63B 29/08; A45B 7/00; E06C 1/34; E06C 1/38; E06C 7/08

(52) U.S. Cl. CPC A63B 29/08; A45B 7/00; E06C 1/34; E06C 1/381; E06C 7/08

(57) ABSTRACT

An injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

### CROSS-REFERENCE TO RELATED APPLICATIONS

This application is a continuation of U.S. application Ser. No. 17/829,835, filed Jun. 1, 2022, and entitled “CLIMBING STICK,” the entire disclosure of which is hereby incorporated by reference.

### BACKGROUND OF THE DISCLOSURE

The present disclosure generally relates to a climbing stick. More specifically, the present disclosure relates to an injection-molded climbing stick that includes a plurality of fibers.

### SUMMARY OF THE DISCLOSURE

According to one aspect of the present disclosure, an injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Further, each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a climbing stick.

FIG. 2 is a top perspective view of a climbing stick.

FIG. 3 is a bottom perspective view of a climbing stick.

FIG. 4 is a rear elevational view of a climbing stick.

FIG. 5 is a bottom perspective view of a rear side of a climbing stick.

FIG. 6 is a side elevational view of a climbing stick.

FIG. 7 is a top plan view of a climbing stick.

FIG. 8 is a bottom plan view of a climbing stick.

FIG. 9 is a front elevational view of a climbing stick, illustrating a direction that is parallel to a length of a post of the climbing stick.

FIG. 10 is a schematic representation of area X of the post of FIG. 9, illustrating fibers disposed within the post.

FIG. 11 is a schematic representation of area XI of a standoff wall of FIG. 8, illustrating fibers disposed within the standoff wall.

The components in the figures are not necessarily to scale, emphasis instead being placed upon illustrating the principles described herein.

### DETAILED DESCRIPTION

The present illustrated embodiments reside primarily in apparatus components related to a climbing stick. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

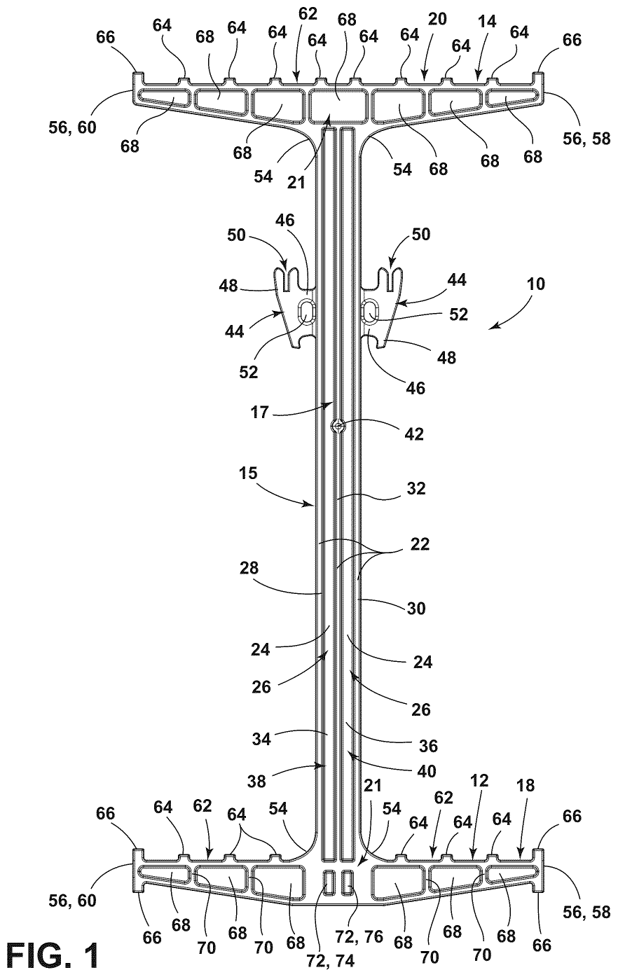

For purposes of description herein, the terms “upper,” “lower,” “right,” “left,” “lateral,” “rear,” “front,” “vertical,” “horizontal,” “upward,” “downward” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. Unless stated otherwise, the term “forward” shall refer to toward the intended viewer and/or closer to the intended viewer based on the context. For example, the phrase “extending forward” shall be interpreted as extending toward the intended viewer, while a first element being “forward of” a second element shall refer to the first element being closer than the second element to the intended viewer. Unless stated otherwise, the term “rearward” shall refer to away from the intended viewer and/or further from the intended viewer based on the context. For example, the phrase “extending rearward” shall be interpreted as extending away from the intended viewer, while a first element being “rearward of” a second element shall refer to the first element being further than the second element from the intended viewer. Unless stated otherwise, the term “lateral” and derivatives thereof shall refer to left-right directions. However, it is to be understood that the disclosure may assume various alternative orientations, except where expressly specified to the contrary. It is also to be understood that the specific devices illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

For purposes of this disclosure, the term “coupled” (in all of its forms: couple, coupling, coupled, etc.) generally means the joining of two components (electrical or mechanical) directly or indirectly to one another. Such joining may be stationary or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Referring to FIGS. 1-10, reference numeral 10 generally designates a climbing stick. The climbing stick 10 may be an injection-molded climbing stick 10, as described further herein. The injection-molded climbing stick 10 includes a first step 12, a second step 14, and a post 15. The post 15 extends from the first step 12 to the second step 14 along a length of the post 15. The post 15 comprises a plurality of fibers 16 that includes every fiber 16 that is disposed within the post 15. The plurality of fibers 16 includes a sub-plurality of fibers 16. Each fiber 16 in the sub-plurality of fibers 16 is elongated in a lengthwise direction of the fiber 16 and oriented such that the lengthwise direction is substantially parallel to the length of the post 15. The sub-plurality of fibers 16 includes a majority of the fibers 16 in the plurality of fibers 16.

Referring now to FIGS. 1-6, the climbing stick 10 includes the first step 12, the second step 14, and the post 15 that extends between the first and second steps 12, 14. In the embodiment illustrated in FIG. 1, the first step 12 of the climbing stick 10 is a bottom step 18, and the second step 14 is a top step 20 that is positioned upward of the bottom step 18. In various implementations, the first step 12 may be the top step 20 and the second step 14 may be the bottom step 18 positioned downward of the top step 20. The post 15 of the climbing stick 10 extends from the first step 12 to the second step 14 along the length of the post 15.

The post 15 can include a plurality of walls 22 that protrude outward from at least one floor portion 24 of the post 15 and, further, extend in a lengthwise direction L of the post 15 (i.e., along the length of the post 15). The plurality of walls 22 and the at least one floor portion 24 of the post 15 may cooperate to define at least one channel 26 that extends along the length of the post 15. For example, as illustrated in FIGS. 1-3, the post 15 includes a first outer wall 28 that extends in the lengthwise direction L of the post 15, a second outer wall 30 that extends in the lengthwise direction L of the post 15, and an inner wall 32 that extends in the lengthwise direction L of the post 15. The inner wall 32 is positioned between the first and second outer walls 28, 30.

In the embodiment illustrated in FIG. 1, a first floor portion 34 extends in the lengthwise direction L of the post 15 and extends between the first outer wall 28 and the inner wall 32. A second floor portion 36 extends in the lengthwise direction L of the post 15 and extends between the second outer wall 30 and the inner wall 32. The first outer wall 28, the inner wall 32, and the first floor portion 34 define a first channel 38 that extends along the lengthwise direction L of the post 15. The second outer wall 30, the inner wall 32, and the second floor portion 36 define a second channel 40 that extends along the lengthwise direction L of the post 15. As illustrated in FIG. 1, the surfaces of the first and second floor portions 34, 36 of the post 15 that define the first and second channels 38, 40, respectively, face forward. Further, the inner wall 32 and the first and second outer walls 28, 30 extend forward from the first and second floor portions 34, 36.

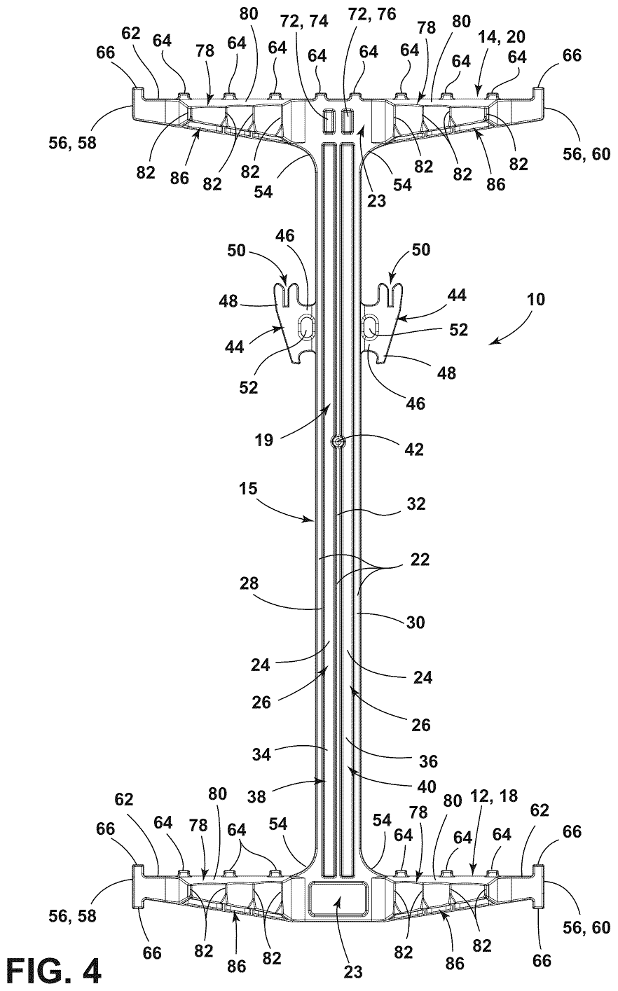

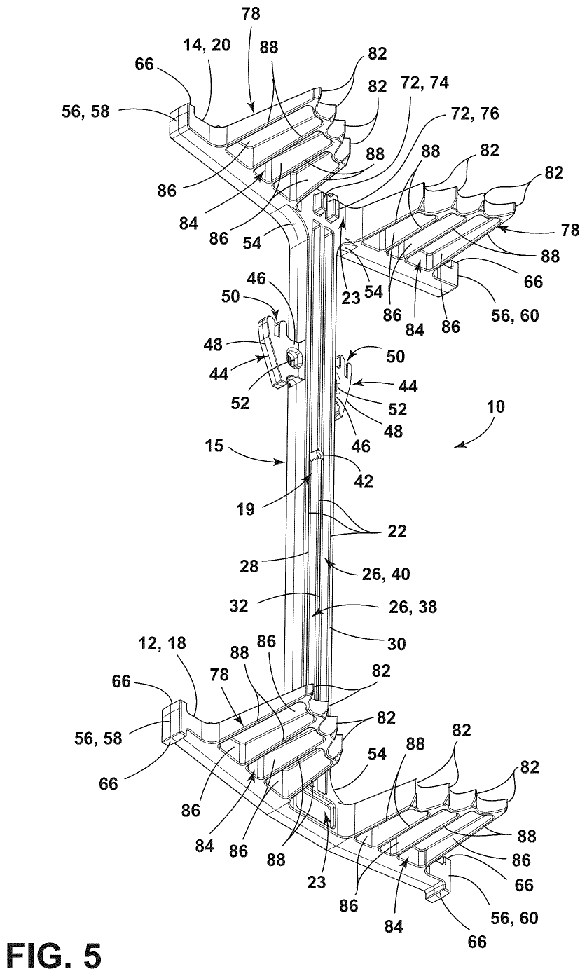

Referring now to FIGS. 4 and 5, in some embodiments, the post 15 includes at least one floor portion 24 that includes a channel-defining surface that faces rearward. For example, as illustrated in FIGS. 4 and 5, the post 15 includes first and second floor portions 34, 36 that face rearward and an inner wall 32 and first and second outer walls 28, 30 that extend rearward from the first and second floor portions 34, 36. As such, first and second channels 38, 40 are defined on the rear side 19 of the post 15. In various embodiments, one or more channels 26 can be defined on the front side 17 of the post 15 and the rear side 19 of the post 15. For example, the post 15 can include first and second floor portions 34, 36, an inner wall 32, and first and second outer walls 28, 30 that cooperate to define first and second channels 38, 40 on both the front and rear sides 17, 19 of the post 15. It is contemplated that one or more channels 38, 40 that are defined by the front and/or rear sides 17, 19 of the post 15 may extend beyond the post 15, such that the one or more channels 38, 40 are additionally defined by portions of the first and/or second steps 12, 14.

Referring now to FIGS. 1-5, the post 15 can define an aperture 42. As illustrated in FIGS. 1-5, the inner wall 32 of the post 15 at least partially defines the aperture 42 that extends through the post 15. In various embodiments, the inner wall 32 wholly defines the aperture 42 that extends through the post 15. The aperture 42 defined by the post 15 may be configured to receive a fastener for attaching a strap to the post 15 of the climbing stick 10 for selectively strapping multiple climbing sticks 10 together for transportation purposes.

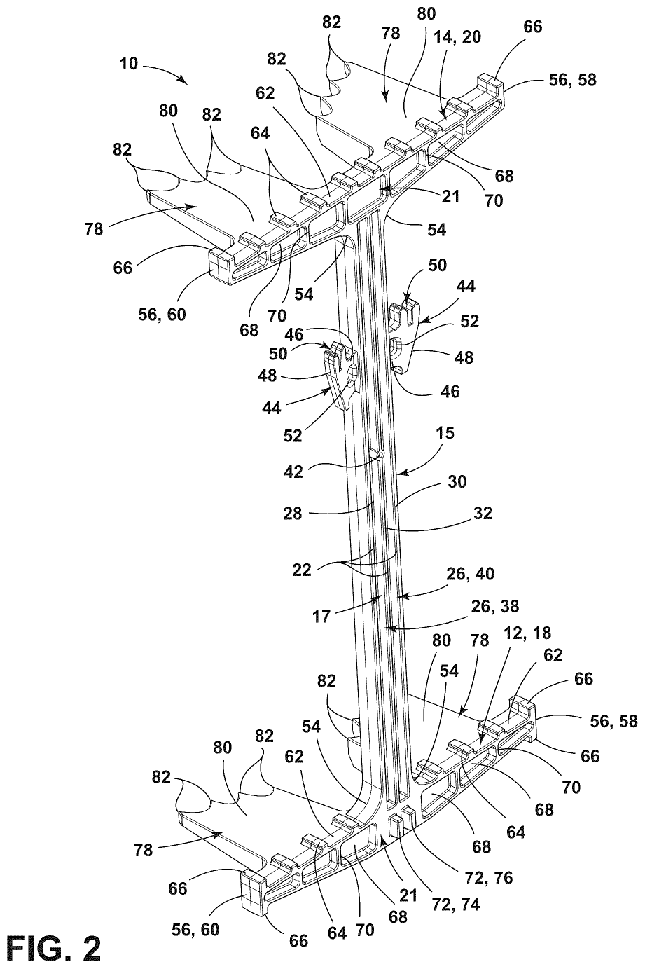

Referring now to FIGS. 1-8, the climbing stick 10 can include a cleat 44. In various embodiments, the climbing stick 10 can include a plurality of cleats 44. For example, as illustrated in FIGS. 1-5, the climbing stick 10 includes two cleats 44. The cleat 44 is coupled to the post 15 between the first and second steps 12, 14 of the climbing stick 10. In various embodiments, the cleat 44 is coupled to the post 15 between the front and rear sides 17, 19 of the post 15, as illustrated in FIGS. 2, 3, 5, and 6. The cleat 44 includes a neck 46 that is coupled to the post 15 and extends outward therefrom. The cleat 44 further includes a head 48 that is coupled to the neck 46 distally from the post 15. In various implementations, the head 48 defines a slot 50. In the embodiment illustrated in FIG. 2, the slot 50 is defined on an upper side of the head 48, such that the slot 50 faces generally upward toward the second step 14 (i.e., the top step 20). It is contemplated that the slot 50 may face a variety of directions in various embodiments. In some embodiments, the slot 50 defined by the cleat 44 may have a width of about two millimeters. The slot 50 being about 2 mm wide may snuggly accommodate certain types of rope that may be used to secure the climbing stick 10 to a tree, such as Paracord™. In some implementations, the cleat 44 defines a cleat aperture 52. For example, as illustrated in FIGS. 1-5, the neck 46 of the cleat 44 defines a cleat aperture 52.

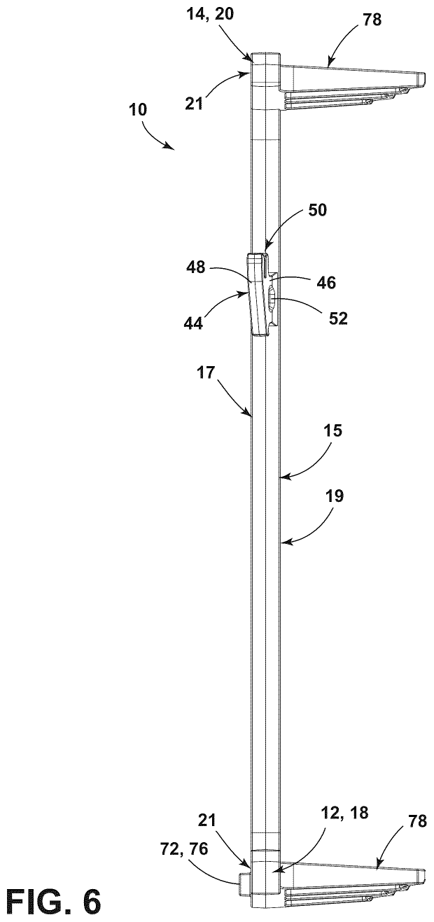

Referring now to FIG. 6, in some implementations, the cleat 44 coupled to the post 15 of the climbing stick 10 angles forward and laterally-outboard from the post 15. In various embodiments, the cleat 44 is angled, such that a portion of the cleat 44 is positioned further forward than the forward-most surface of the post 15. For example, as illustrated in FIG. 6, a portion of the cleat 44 that is distal from the post 15 extends forward beyond the forward-most surface of the post 15. In various embodiments, the portion of the neck 46 of the cleat 44 that is proximal to the post 15 may be positioned wholly between the forward-most surface of the post 15 and the rearward-most surface of the post 15.

Referring now to FIGS. 1-8, the climbing stick 10 includes the first and second steps 12, 14. In the illustrated embodiments, the first step 12 is the bottom step 18 and the second step 14 is the top step 20 positioned upward of the bottom step 18. As illustrated in FIG. 1, the post 15 extends between the first and second steps 12, 14 and is coupled to the first and second steps 12, 14 at corners 54. As illustrated, the corners 54 are generally rounded, which may advantageously influence resin flow and fiber orientation during injection molding of the climbing stick 10, as described further herein. As further illustrated in FIG. 1, the first and second steps 12, 14 extend laterally-outboard from the post 15 to laterally-distal ends 56 of the first and second steps 12, 14, respectively. In other words, as illustrated in FIG. 1, the first step 12 extends outward from the post 15 to the right to a right laterally-distal end 58 of the first step 12, and the first step 12 extends outward from the post 15 to the left to a left laterally-distal end 60 of the first step 12. Further, the second step 14 extends outward from the post 15 to the right to a right laterally-distal end 58 of the second step 14, and the second step 14 extends outward from the post 15 to the left to a left laterally-distal end 60 of the second step 14.

The first and second steps 12, 14 each include an upper stepping surface 62. The upper stepping surface 62 faces upward and is configured to support the foot of a user standing on the first and/or second step 12, 14. As illustrated in FIGS. 1-4, a plurality of traction ridges 64 extend upward from the upper stepping surfaces 62 of the first and second steps 12, 14. The traction ridges 64 extend in a forward-rearward direction and are spaced apart from each other in the lateral direction along the upper stepping surface 62 of each of the first and second steps 12, 14.

As illustrated in FIG. 1, the first step 12 includes a tang 66 that extends downward from the first step 12 away from the second step 14. It is contemplated that the first step 12 may include a plurality of tangs 66 that extend downward from the first step 12. For example, in the embodiment illustrated in FIG. 1, the first step 12 includes two tangs 66 that extend downward from the first step 12. The tang 66 may extend downward at the laterally-distal end 56 of the first step 12, in some embodiments. For example, in the embodiment illustrated in FIG. 1, the two tangs 66 of the first step 12 extend downward from the first step 12 at the left and right laterally-distal ends 60, 58 of the first step 12, respectively.

Referring still to FIG. 1, the second step 14 can include a tang 66 that extends upward from the second step 14 away from the first step 12. The second step 14 can include a plurality of tangs 66 that extend upward from the second step 14. For example, as illustrated in FIG. 1, the second step 14 includes two tangs 66 that extend upward from the second step 14. The tang 66 of the second step 14 can extend upward at the laterally-distal end 56 of the second step 14. For example, as illustrated in FIG. 1, the two tangs 66 of the second step 14 extend upward from the second step 14 at the left and right laterally-distal ends 60, 58 of the second step 14, respectively.

In various implementations, the tang 66 of the second step 14 can extend upward from the upper stepping surface 62 of the second step 14 further than the traction ridges 64 of the second step 14 extend upward from the upper stepping surface 62 of the second step 14. In some embodiments, one or more of the tangs 66 of the first and second steps 12, 14 are laterally aligned with each other. In other words, the tang 66 of the first step 12 and the tang 66 of the second step 14 may be positioned relative to each other such that both tangs 66 fall within a plane extending normal to the lateral direction. In the embodiment illustrated in FIG. 1, the tang 66 positioned at the left laterally-distal end 60 of the first step 12 is laterally aligned with the tang 66 positioned at the left laterally-distal end 60 of the second step 14. Further, the tang 66 of the right laterally-distal end 58 of the first step 12 is laterally aligned with the tang 66 of the right laterally-distal end 58 of the second step 14.

In some embodiments, the first step 12 can include at least one tang 66 that extends upward from the laterally-distal ends 56 of the first step 12. For example, in the embodiment illustrated in FIG. 1, two tangs 66 extend upward from the left and right laterally-distal ends 60, 58 of the first step 12, and two tangs 66 extend downward from the left and right laterally-distal ends 60, 58 of the first step 12. In operation, the upward extending tangs 66 of the first and second steps 12, 14, which extend upward from the laterally-distal ends 56 of the first and second steps 12, 14, respectively, can serve as a tactile indication of where the laterally-distal ends 56 of the first and second steps 12, 14 are while the user is climbing. Further, the downward extending tangs 66 of the first step 12 and the upward extending tangs 66 of the second step 14 may act as hooks that can retain rope coiled about the first and second steps 12, 14.

Referring now to FIGS. 1-3, the first and/or second steps 12, 14 can define a plurality of step recesses 68. In various embodiments, the front side 21 of the first step 12 and/or the front side 21 of the second step 14 defines the plurality of step recesses 68. As illustrated in FIG. 1, the plurality of step recesses 68 may be separated from each other and partially defined by one or more step walls 70. As illustrated in FIG. 1, the step walls 70 may extend generally parallel to the length of the post 15 and may have substantially the same lateral width as the inner wall 32 of the post 15. The first and/or second steps 12, 14 defining the step recesses 68 separated by the step walls 70 may advantageously influence the flow of resin and the orientation of fibers 16 within the climbing stick 10 during the injection molding process, such that the structural integrity of the climbing stick 10 is enhanced.

Referring now to FIGS. 1-8, the climbing stick 10 can include a protrusion 72. In various embodiments, the climbing stick 10 includes a plurality of protrusions 72. In some embodiments, at least one protrusion 72 extends outward from at least one of the first and second steps 12, 14 in a forward direction. It is contemplated that the at least one protrusion 72 can extend outward from the front and/or rear side 17, 19 of the post 14, in some embodiments. The at least one protrusion 72 can be laterally aligned with the at least one channel 26 defined by the post 15 of the climbing stick 10. As illustrated in FIGS. 1-3, the climbing stick 10 includes first and second protrusions 74, 76 that extend forward from the first step 12 and are positioned to be laterally aligned with the first and second channels 38, 40 of the post 15, respectively. The first and second protrusions 74, 76 are offset from the channels 26 of the post 15 in the forward direction. In various embodiments, a lateral width of the at least one protrusion 72 can be less than the lateral width of the at least one channel 26 of the post 15. As illustrated in FIGS. 1-3, the first protrusion 74 extends outward from the first step 12 in the forward direction and is laterally aligned with the first channel 38 of the post 15. The lateral width of the first protrusion 74 is less than the lateral width of the first channel 38. Further, the second protrusion 76 extends outward from the first step 12 of the climbing stick 10 in the forward direction. The second protrusion 76 is laterally aligned with the second channel 40, and the lateral width of the second protrusion 76 is less than the lateral width of the second channel 40 defined by the post 15.

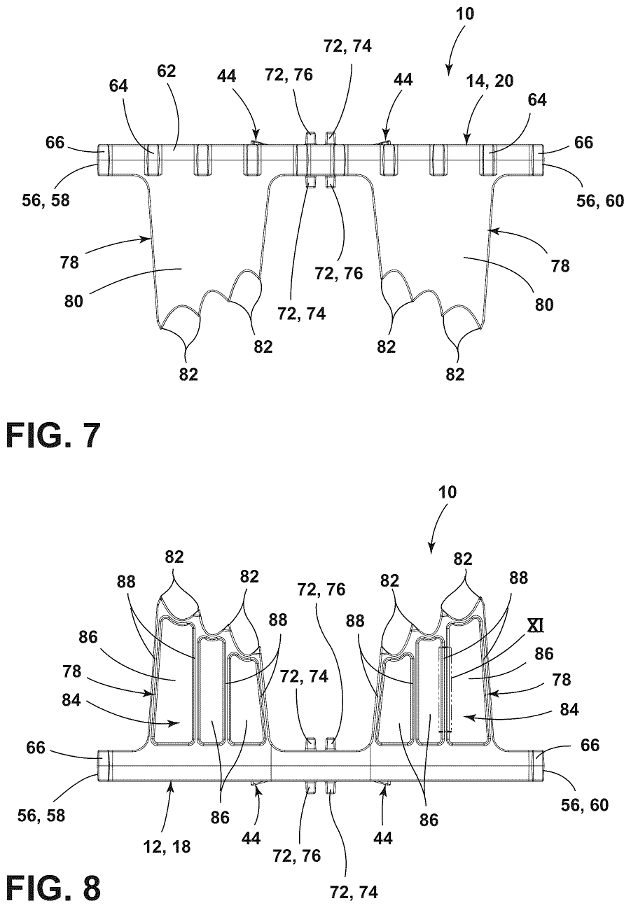

Referring now to FIGS. 4-8, the climbing stick 10 can include at least one protrusion 72 that extends rearward from a rear side 23 of at least one of the first and second steps 12, 14. As illustrated in FIGS. 4-6, first and second protrusions 74, 76 extend rearward from the second step 14 of the climbing stick 10. The first and second protrusions 74, 76 extending rearward from the second step 14 are laterally aligned with first and second channels 38, 40, respectively, that are defined on the rear side 19 of the post 15. In various embodiments, the climbing stick 10 can include at least one protrusion 72 that extends forward from at least one of the first and second steps 12, 14 and at least one protrusion 72 that extends rearward from at least one of the first and second steps 12, 14. For example, as illustrated in FIGS. 7 and 8, the climbing stick 10 includes first and second protrusions 74, 76 that extend forward from the first step 12 and first and second protrusions 74, 76 that extend rearward from the second step 14. In operation, the protrusions 72 of the climbing stick 10 are configured to slidingly engage with channels 26 of additional climbing sticks 10 such that multiple climbing sticks may be engaged with each other in a stacked configuration for convenient, compact transportation.

Referring now to FIGS. 2-8, the climbing stick 10 includes at least one standoff 78. The at least one standoff 78 is configured to engage with a tree while the climbing stick 10 is in use. In various embodiments, the climbing stick 10 includes a plurality of standoffs 78 that are configured to engage with a tree. The at least one standoff 78 can extend rearward from the first and/or second steps 12, 14 of the climbing stick 10. In the embodiment illustrated in FIGS. 2-8, the climbing stick 10 includes two standoffs 78 that extend rearward from the first step 12 and two standoffs 78 that extend rearward from the second step 14. As illustrated in FIGS. 2-5, 7, and 8, each standoff 78 of the climbing stick 10 is positioned laterally between one of the laterally-distal ends 56 of one of the first and second steps 12, 14 and the post 15 of the climbing stick 10. As shown in FIGS. 1 and 2, upper surfaces 80 of the standoffs 78 that extend rearward from the first step 12 may be substantially flush with the upper stepping surface 62 of the first step 12 adjacent to the first step 12. Further, the upper surfaces 80 of the standoffs 78 that extend rearward from the second step 14 may be substantially flush with the upper stepping surface 62 of the second step 14 adjacent to the second step 14.

Referring now to FIGS. 2, 3, 5, 7, and 8, the at least one standoff 78 coupled to the first step 12 may extend rearward from the first step 12 to a plurality of teeth 82 that are distal from the first step 12. Further, the at least one standoff 78 coupled to the second step 14 may extend rearward from the second step 14 to a plurality of teeth 82. The plurality of teeth 82 may be configured to engage with a tree trunk during use of the climbing stick 10.

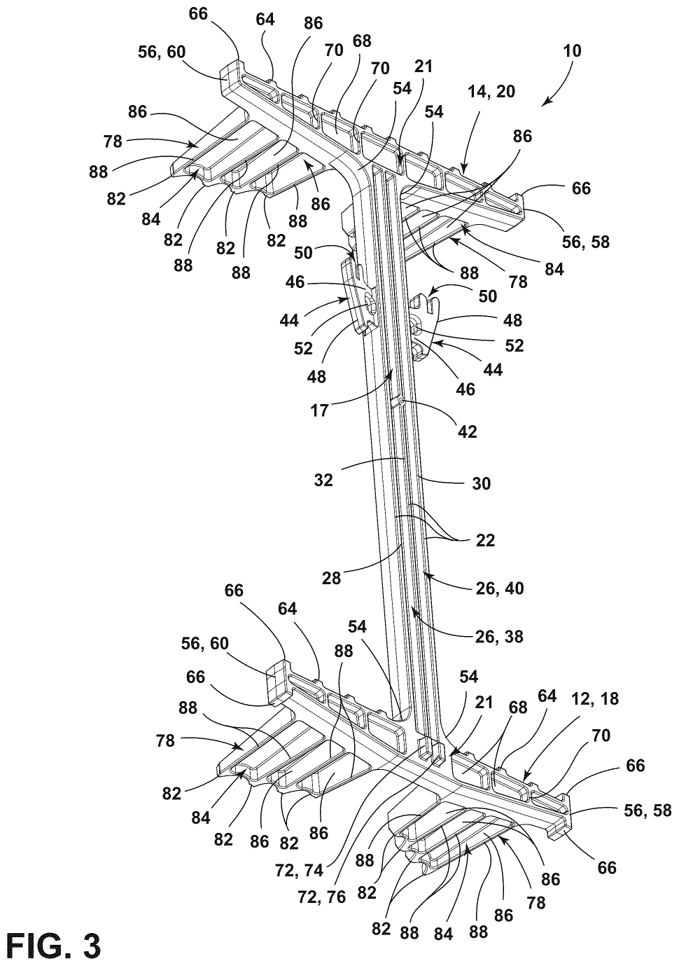

In various embodiments, a bottom side 84 of the at least one standoff 78 of the climbing stick 10 defines a plurality of standoff recesses 86. The plurality of standoff recesses 86 can be separated from each other and/or partially defined by a plurality of standoff walls 88, as illustrated in FIGS. 3, 5, and 8. At least one standoff wall 88 may extend rearward from the first and/or second steps 12, 14 along a length of the at least one standoff wall 88. In some implementations, one or more standoff walls 88 may extend rearward from the first and/or second steps 12, 14 and generally align with the teeth 82 of the at least one standoff 78, as illustrated in FIG. 8. In some embodiments, the length of the at least one standoff wall 88 may be substantially perpendicular to the length of the post 15. The at least one standoff 78 having a plurality of standoff recesses 86 that are separated by and partially defined by standoff walls 88 may advantageously influence the flow of resin and the orientation of fibers 100 during injection molding of the climbing stick 10, such that the structural integrity of the climbing stick 10 is enhanced. Further, the orientation of fibers 100 within the at least one standoff wall 88 may enhance the structural integrity of the at least one standoff 78, as described further herein.

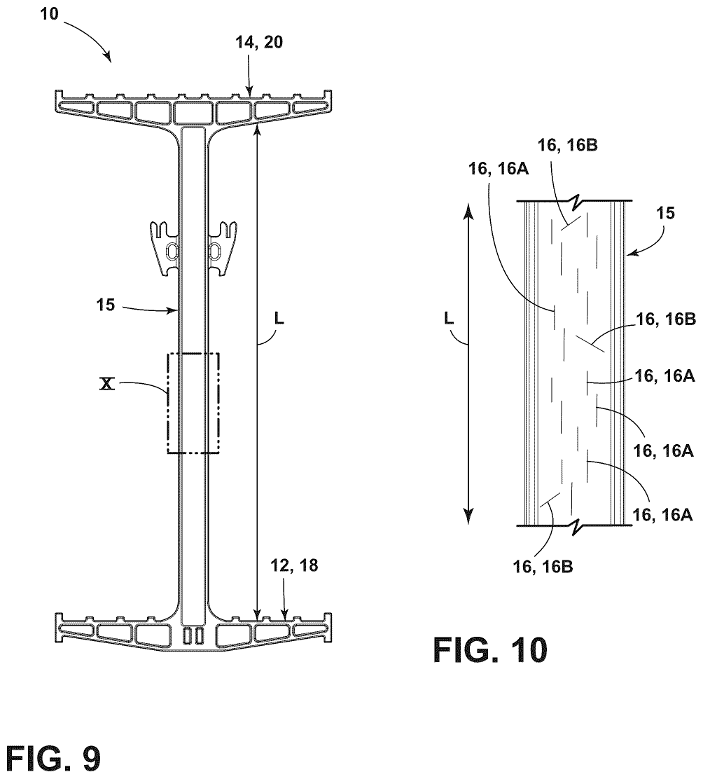

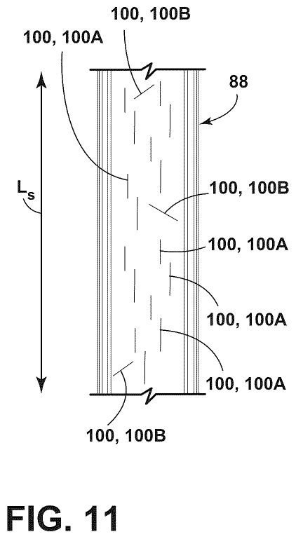

Referring now to FIGS. 9 and 10, the climbing stick 10 can be an injection-molded climbing stick 10. As such, the climbing stick 10 may be formed of a resin that is injected into a mold and cooled to form an integral component. A variety of types of resins, such as thermoplastics, are contemplated. Further, a variety of types of thermoplastics are contemplated. The injection-molded climbing stick 10 may further be formed of a plurality of fibers 16 that are disposed within the resin. A variety of types of fibers 16 are contemplated. For example, the injection-molded climbing stick 10 may include one or more of a host of types of fibers 16 that may include, but is not limited to, carbon, glass, aramid, basalt, polyacrylonitrile, polyethylene terephthalate, and/or polypropylene fibers. Further, the injection-molded climbing stick 10 can include long fibers 16 and/or short fibers 16. In an exemplary embodiment, the injection-molded climbing stick 10 is formed of a thermoplastic resin and short carbon fibers 16. As such, the climbing stick 10 is a short carbon fiber-reinforced thermoplastic climbing stick 10. Various combinations of resins and fibers 16 are contemplated.

In various embodiments, fibers 16 disposed within the climbing stick 10 are aligned with each other and/or aligned with a given climbing stick-direction to enhance the structural integrity of the climbing stick 10. For example, fibers 16 disposed within the post 15 of the climbing stick 10 may be aligned with each other along the length of the post 15. In an exemplary embodiment, wherein the post 15 extends from the first step 12 to the second step 14 along the length of the post 15, the post 15 comprises a plurality of fibers 16 that includes every fiber 16 that is disposed within the post 15 of the climbing stick 10. The plurality of fibers 16 includes a sub-plurality of fibers 16. Each fiber 16 in the sub-plurality of fibers 16 is elongated in a lengthwise direction of the fiber. Further, each fiber 16A in the sub-plurality of fibers 16 is oriented such that the lengthwise direction is substantially parallel to the length of the post 15. In various embodiments, the plurality of fibers 16 that includes every fiber 16 that is disposed within the post 15 includes fibers 16B that are not oriented such that the lengthwise direction of the fiber 16B is substantially parallel to the length of the post 15. For example, as illustrated in FIG. 10, there are fibers 16A that are substantially parallel relative to the length of the post 15 and fibers 16B that are not substantially parallel relative to the length of the post 15.

In various embodiments, the sub-plurality of fibers 16 includes a majority of the fibers 16 in the plurality of fibers 16 disposed within the post 15. In some embodiments, the sub-plurality of fibers 16 includes between about 60% and 100% of the fibers 16 in the plurality of fibers 16. In some embodiments, the sub-plurality of fibers 16 includes between about 75% and 100% of the fibers 16 in the plurality of fibers 16. In some embodiments, the sub-plurality of fibers 16 includes between about 90% and 100% of the fibers 16 in the plurality of fibers 16. In some embodiments, the sub-plurality of fibers 16 includes between about 95% and 100% of the fibers 16 in the plurality of fibers 16. In some embodiments, the sub-plurality of fibers 16 includes between about 99% and 100% of the fibers 16 in the plurality of fibers 16.

In various embodiments, fibers 16 are oriented substantially parallel to the length of the post 15 when the lengthwise direction of the fiber 16 is angled less than about 30 degrees relative to the length of the post 15. In some embodiments, substantially parallel to the length of the post 15 is an angle of less than about 15 degrees relative to the length of the post 15. In some embodiments, substantially parallel to the length of the post 15 is an angle of less than about 10 degrees relative to the length of the post 15. In some embodiments, substantially parallel to the length of the post 15 is an angle of less than about 5 degrees relative to the length of the post 15.

In some embodiments, fibers 100 disposed within the at least one standoff wall 88 are aligned with each other along the length L_{S} of the standoff wall 88. In an exemplary embodiment, wherein the standoff wall 88 extends rearward from the first step 12 along the length of the standoff wall 88, the standoff wall 88 comprises a plurality of fibers 100 that includes every fiber 100 that is disposed within the standoff wall 88 of the climbing stick 10. The plurality of fibers 100 within the standoff wall 88 includes a sub-plurality of fibers 100A. Each fiber 100A in the sub-plurality of fibers 100A is elongated in the lengthwise direction of the fiber 100A. Further, each fiber 100A in the sub-plurality of fibers 100A is oriented such that the lengthwise direction is substantially parallel to the length of the standoff wall 88. In various embodiments, the plurality of fibers 100 that includes every fiber 100 that is disposed within the standoff wall 88 includes fibers 100B that are not oriented such that the lengthwise direction of the fiber 100B is substantially parallel to the length of the standoff wall 88.

In various embodiments, the sub-plurality of fibers 100A includes a majority of the fibers 100 in the plurality of fibers 100 disposed within the standoff wall 88. In some embodiments, the sub-plurality of fibers 100A includes between about 60% and 100% of the fibers 100 in the plurality of fibers 100 disposed within the standoff wall 88. In some embodiments, the sub-plurality of fibers 100A includes between about 75% and 100% of the fibers 100 in the plurality of fibers 100 disposed within the standoff wall 88. In some embodiments, the sub-plurality of fibers 100A includes between about 90% and 100% of the fibers 100 in the plurality of fibers 100 disposed within the standoff wall 88. In some embodiments, the sub-plurality of fibers 100A includes between about 95% and 100% of the fibers 100 in the plurality of fibers 100 disposed within the standoff wall 88. In some embodiments, the sub-plurality of fibers 100A includes between about 99% and 100% of the fibers 100 in the plurality of fibers 100 disposed within the standoff wall 88.

In various embodiments, fibers 100 are oriented substantially parallel to the length of the standoff wall 88 when the lengthwise direction of the fiber 100 is angled less than about 30 degrees relative to the length of the standoff wall 88. In some embodiments, substantially parallel to the length of the standoff wall 88 is an angle of less than about 15 degrees relative to the length of the standoff wall 88. In some embodiments, substantially parallel to the length of the standoff wall 88 is an angle of less than about 10 degrees relative to the length of the standoff wall 88. In some embodiments, substantially parallel to the length of the standoff wall 88 is an angle of less than about 5 degrees relative to the length of the standoff wall 88.

The present disclosure may provide a variety of advantages. First, forming the climbing stick 10 from a thermoplastic resin via injection molding results in the climbing stick 10 being significantly lighter than similarly sized climbing sticks 10 that are formed of conventional materials, such as metal. Second, despite the reduced weight of the climbing stick 10 enabled by use of the thermoplastic material, the sub-plurality of fibers 16A that are oriented substantially parallel with the length of the post 15 of the climbing stick 10 ensure that the climbing stick 10 has sufficient structural integrity for conventional use. Third, the channels 26 defined by the post 15 contribute to climbing stick weight reduction, influence resin flow and fiber 16 orientation within the post 15, and are configured to receive protrusions 72 of other climbing sticks 10 therein, such that multiple climbing sticks 10 may be slidingly engaged with each other for convenient, compact storage and transportation. Fourth, the cleat 44 angling forward and outboard from the post 15 of the climbing stick 10 may increase the ease with which a user can fasten the climbing stick 10 to a tree by providing additional space between the tree and the rear side of the cleat 44. Fifth, the first and second steps 12, 14 including downward and upward extending tangs 66, respectively, may allow a user to securely coil the tag end of a rope about the first and second steps 12, 14 of the climbing stick 10. Sixth, the step recesses 68 and standoff recesses 86 being separated from each other by the step walls 70 and standoff walls 88, respectively, may advantageously influence the flow of resin and the orientation of fibers 16, 100 within the resin during injection molding of the climbing stick 10 to increase the structural integrity of the climbing stick 10 while reducing the overall weight of the climbing stick 10.

According to an aspect of the present disclosure, an injection-molded climbing stick includes a first step, a second step, and a post extending from the first step to the second step along a length of the post and comprising a plurality of fibers that includes every fiber that is disposed within the post. The plurality of fibers includes a sub-plurality of fibers. Further, each fiber in the sub-plurality of fibers is elongated in a lengthwise direction of the fiber and oriented such that the lengthwise direction is substantially parallel to the length of the post, and the sub-plurality of fibers includes a majority of the fibers in the plurality of fibers.

According to another aspect, the sub-plurality of fibers includes between about 60 percent and 100 percent of the fibers in the plurality of fibers.

According to another aspect, the sub-plurality of fibers includes between about 75 percent and 100 percent of the fibers in the plurality of fibers.

According to another aspect, the sub-plurality of fibers includes between about 90 percent and 100 percent of the fibers in the plurality of fibers.

According to another aspect, substantially parallel to the length of the post is an angle of less than about 30 degrees relative to the length of the post.

According to another aspect, substantially parallel to the length of the post is an angle of less than about 15 degrees relative to the length of the post.

According to another aspect, substantially parallel to the length of the post is an angle of less than about 10 degrees relative to the length of the post.

According to another aspect, substantially parallel to the length of the post is an angle of less than about 5 degrees relative to the length of the post.

According to another aspect, a cleat is coupled to the post between the first and second steps and includes a neck coupled to the post and extending outward therefrom and a head coupled to the cleat distally from the post and wholly defining a slot.

According to another aspect, the cleat defines a cleat aperture.

According to another aspect, the cleat angles forward and laterally-outboard from the post.

According to another aspect, the first step is a bottom step and the second step is a top step positioned upward of the bottom step, and the slot defined by the head of the cleat faces generally upward toward the top step.

According to another aspect, the post includes a first outer wall that extends in a lengthwise direction of the post, a second outer wall that extends in the lengthwise direction of the post, an inner wall that extends in the lengthwise direction of the post and is positioned between the first and second outer walls, a first floor portion that extends in the lengthwise direction of the post and extends between the first outer wall and the inner wall, and a second floor portion that extends in the lengthwise direction of the post and extends between the second outer wall and the inner wall. The first outer wall, the inner wall, and the first floor portion define a first channel that extends along the lengthwise direction of the post, and the second outer wall, the inner wall, and the second floor portion define a second channel that extends along the lengthwise direction of the post.

According to another aspect, the inner wall at least partially defines an aperture that extends through the post.

According to another aspect, a first protrusion extends outward from one of the first and second steps and is laterally aligned with the first channel. A lateral width of the first protrusion is less than a lateral width of the first channel. Further, a second protrusion extends outward from one of the first and second steps and is laterally aligned with the second channel. A lateral width of the second protrusion is less than a lateral width of the second channel.

According to another aspect, the first protrusion extends outward from the first step in a forward direction.

According to another aspect, the first step is a bottom step and the second step is a top step positioned upward of the bottom step, and the first step includes a tang that extends downward from the first step away from the second step.

According to another aspect, the second step includes a tang that extends upward from the second step and away from the first step. The tangs of the first and second steps are laterally aligned with each other.

According to another aspect, a standoff extends rearward from the first step.

According to yet another aspect, a front side of the first step defines a plurality of step recesses, and a bottom side of the standoff defines a plurality of standoff recesses.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A climbing stick comprising:
a first step;
a second step;
a post extending between the first and second steps; and
a cleat coupled to the post between the first and second steps, the cleat comprising:
a neck coupled to the post and extending outward away from the post; and
a head coupled to the neck distally from the post, wherein the head wholly defines a slot.

2. The climbing stick of claim 1, wherein the first step is a bottom step and the second step is a top step positioned upward of the bottom step.

3. The climbing stick of claim 2, wherein the head of the cleat comprises:
a first projecting portion that extends upward from the neck; and
a second projecting portion that is positioned further than the first projecting portion from the neck, wherein the first and second projecting portions cooperate to define the slot therebetween.

4. The climbing stick of claim 3, wherein the head of the cleat further comprises:
a third projecting portion that extends downward from the neck of the cleat.

5. The climbing stick of claim 4, wherein the third projecting portion is partially formed by a laterally-outboard side of the head that faces away from the post, and the laterally-outboard side of the head includes a first portion that extends upward and laterally outboard to a second portion of the laterally-outboard side of the head that extends upward from the first portion, wherein a portion of the first portion of the laterally-outboard side of the head forms a portion of the third projecting portion, and a portion of the second portion of the laterally-outboard side of the head forms a portion of the second projecting portion of the head.

6. The climbing stick of claim 5, wherein the first portion extends laterally outboard as the first portion extends upward toward the second portion to a greater extent than the second portion extends laterally outboard as the second portion extends upward away from the first portion.

7. The climbing stick of claim 6, wherein the second portion extends upward and laterally outboard from the first portion.

8. The climbing stick of claim 6, wherein the first projecting portion includes a sloped portion that extends downward and radially outboard and partially defines an upper opening of the slot.

9. The climbing stick of claim 8, wherein the sloped portion of the first projecting portion is positioned upward of the neck of the cleat.

10. The climbing stick of claim 9, wherein the slot has a width of about 2 millimeters.

11. The climbing stick of claim 9, wherein the cleat is a first cleat that extends outward away from the post in a first lateral direction, and the climbing stick further comprises:
a second cleat that extends outward away from the post in a second lateral direction opposite the first lateral direction.

12. The climbing stick of claim 11, wherein the first and second cleats are integrally coupled.

13. The climbing stick of claim 12, wherein the first cleat, the second cleat, and the post are integrally coupled.

14. The climbing stick of claim 9, wherein the first step includes a tang that extends downward from the first step away from the second step.

15. The climbing stick of claim 14, wherein a laterally distal end of the first step is nearer than the post to the tang.

16. A climbing stick comprising:
a bottom step that includes a first laterally-distal end, a second-laterally distal end opposite the first laterally-distal end, an upper stepping surface positioned between the first and second laterally-distal ends, a first tang that extends downward from the bottom step away from the upper stepping surface at the first laterally-distal end of the bottom step, and a second tang that extends downward from the bottom step away from the upper stepping surface at the second laterally-distal end of the bottom step;
a top step that includes a first laterally-distal end, a second-laterally distal end opposite the first laterally-distal end of the top step, an upper stepping surface positioned between the first and second laterally-distal ends of the top step, a first tang that extends upward from the top step away from the bottom step at the first laterally-distal end of the top step, and a second tang that extends upward from the top step at the second laterally-distal end of the top step; and
a post extending between the top and bottom steps.

17. The climbing stick of claim 16, wherein the first tang of the bottom step and the first tang of the top step are laterally aligned with each other, such that the first tangs fall within a first plane extending normal to the lateral direction.

18. The climbing stick of claim 17, wherein the second tang of the bottom step and the second tang of the top step are laterally aligned with each other, such that the second tangs fall within a second plane extending normal to the lateral direction.

19. The climbing stick of claim 18, wherein the bottom step further comprises:
a third tang that extends upward from the bottom step at the first laterally-distal end of the bottom step; and
a fourth tang that extends upward from the bottom step at the second laterally-distal end of the bottom step.

20. The climbing stick of claim 19, wherein the third tang of the bottom step, the first tang of the bottom step, and the first tang of the top step are laterally aligned with each other, such that the third tang and the first tangs fall within the first plane extending normal to the lateral direction.

21. The climbing stick of claim 20, wherein the fourth tang of the bottom step, the second tang of the bottom step, and the second tang of the first step are laterally aligned with each other, such that the fourth tang and the second tangs fall within the second plane extending normal to the lateral direction.

22. The climbing stick of claim 21, wherein the top step includes a plurality of traction ridges that extend upward from the upper stepping surface of the top step, and the first and second tangs of the top step extend upward from the upper stepping surface of the top step further than the traction ridges extend upward from the upper stepping surface of the top step.

23. The climbing stick of claim 22, wherein the bottom step includes a plurality of traction ridges that extend upward from the upper stepping surface of the bottom step, and the third and fourth tangs of the bottom step extend upward from the upper stepping surface of the bottom step further than the traction ridges of the bottom step extend upward from the upper stepping surface of the bottom step.

24. The climbing stick of claim 16, further comprising:
a cleat coupled to the post between the bottom and top steps, the cleat comprising:
a neck coupled to the post and extending outward away from the post; and
a head coupled to the neck distally from the post.

25. A climbing stick comprising:
a bottom step that includes a first laterally-distal end, a second-laterally distal end opposite the first laterally-distal end, an upper stepping surface positioned between the first and second laterally-distal ends, a first tang that extends downward from the bottom step away from the upper stepping surface at the first laterally-distal end of the bottom step, and a second tang that extends downward from the bottom step away from the upper stepping surface at the second laterally-distal end of the bottom step;
a top step that includes a first laterally-distal end, a second-laterally distal end opposite the first laterally-distal end of the top step, an upper stepping surface positioned between the first and second laterally-distal ends of the top step, a first tang that extends upward from the top step away from the bottom step at the first laterally-distal end of the top step, and a second tang that extends upward from the top step at the second laterally-distal end of the top step;
a post extending between the top and bottom steps; and
a cleat coupled to the post between the bottom and top steps, the cleat comprising:
a neck coupled to the post and extending outward away from the post; and
a head coupled to the neck distally from the post, wherein the head wholly defines a slot.
